(19) United States
(12) Patent Application Publication
(10) Pub. No.: US 2011/0278062 A1
(43) Pub. Date: Nov. 17, 2011

(54) ELECTRICAL CABLE WITH OUTER JACKET BONDED FROM CONDUCTOR TO OUTER JACKET

(76) Inventor: Joseph Varkey, Sugar Land, TX (US)

(21) Appl. No.: 13/107,252

(22) Filed: May 13, 2011

Related U.S. Application Data
(60) Provisional application No. 61/345,393, filed on May 17, 2010.

(51) Int. Cl. H02G 3/00; H01R 43/00

(52) U.S. Cl. 174/70 R; 29/825

(57) ABSTRACT

Embodiments disclosed herein relate to a cable for use with a downhole pump. The cable includes a cable core having at least one metallic conductor and at least one polymer layer bonded to the at least one metallic conductor, the cable further includes and at least one strength member layer bonded to the cable core. The at least one strength member layer may include a plurality of polymer-bonded strength members. Further, the cable may be continuously bonded from the at least one metallic conductor to the at least one strength member layer.

### CROSS REFERENCE TO RELATED APPLICATIONS

This application claims priority to, and therefore claims benefit under 35 U.S.C. §119(e), U.S. Provisional Patent Application No. 61/345,393, filed on May 17, 2010. This provisional application is incorporated by reference in its entirety.

### BACKGROUND

1. Technical Field

Embodiments disclosed herein generally relate to a cable for use with a downhole pump. More particularly, embodiments disclosed herein related to a cable that provides at least power to a downhole pump, in which the cable has multiple layers and materials bonded to each other for increased reliability and/or strength.

2. Background Art

In the oil and gas industry, a wide variety of systems are known for producing fluids from a subterranean formation. Oil wells typically rely on natural gas pressure to propel crude oil to the surface. In formations providing sufficient pressure to force the fluids to the surface of the earth, the fluids may be collected and processed without the use of artificial lifting systems. Oftentimes, particularly in more mature oilfields that have diminished gas pressure or in wells with heavy oil, this pressure is not sufficient to bring the oil out of the well. In these instances, the oil can be pumped out of the wells using a pumping system.

Different types of pumping systems may be disposed downhole with a well to pump the desired fluids to the surface of the earth. For example, sucker rod pumps have been previously used to pump oil to the surface in low pressure wells. More recently, though, sucker rod pumps have been replaced with electrical submersible pumps (ESPs), such as a Russian Electrical Dynamo of Arutunoff (REDA) pump, which is commercially available from Schlumberger. A submersible pump is usually deposited within the production fluids to then pump the desired fluids to the earth's surface. As such, an electrical submersible pump typically includes a motor section, a pump section, and a motor protector to seal the clean motor oil from wellbore fluids, in which the pump is deployed in a well and receives power via an electrical cable. These pumps are typically attached to the bottom of the production string and pump oil up from the bottom of the well by generating a pressure boost sufficient to lift production fluids even in deep water subsea developments. Power to these electrical submersible pumps is typically provided by “permanent” cables designed for long-term deployment in the well.

A typical submersible pumping system includes several components, such as a submersible electric motor that supplies energy to a submersible pump, and typically some kind of connector for connecting the submersible pumping system to a deployment system. Conventional deployment systems often include production tubing, cable, and/or coiled tubing. Additionally, power is supplied to the submersible electric motor via a power cable that runs through or along the deployment system.

As shown in FIG. 1, a submersible pumping system includes a submersible pump 10 attached to a pipe string 12 and deployed in a well 14 via a permanent cable 16, in which the cable 16 terminates at the well head 18. The cable 16 provides power to the submersible pump 10, but typically is not capable of suspending or supporting the submersible pump 10 in the well 14. Rather, the submersible pump 10 is attached to the pipe string 12 (i.e., the pipe string 12 supports the submersible pump 10 in the well 14) and the cable 16 may be either attached to the outside or inside of the pipe string 12. The cable 16 is typically fixed to the pipe string 12 with metal straps (not shown) and cut at the well head 18 to the exact length needed to provide the submersible pump 10 downhole. Once the cable 16 is cut, both the submersible pump 10 and the cable 16 become a permanent fixture with the pipe string 12 in the well 14 (i.e., to remove the submersible pump 10, the entire pipe string 12 must be pulled out of the well 14).

Typically, the subterranean environment presents an extreme environment having high temperatures and pressures. Further, corrosive fluids containing one or more corrosive compounds, such as carbon dioxide, hydrogen sulfide, and/or brine water, may also be injected from the surface into the wellbore (e.g., acid treatments). These extreme conditions can be detrimental to components of the submersible pumping system, and particularly to the internal electrical components of the electric cable. Specifically, electrical cables for submersible pumping systems typically contain conductive cables (e.g., copper cables) that must be protected from the corrosive effects of the well fluids that surround the cable. To protect the electrical cables, it is known in the art to insulate the conductors and then wrap an outer metal armor around a rubber jacket that surrounds the insulated conductors. The outer metal armor is used to protect the insulated conductors from impact and abrasion, while additional metal armor may be wrapped around the insulated conductors to protect against corrosive compounds in the well.

Armored cables, though, normally corrode over time, such as from the metal armor used within the cables, in which such corrosion often causes the cables and/or pump to fail electrically. Additionally, such corrosion may result in portions of the external armor corroding away and thereby fouling and/or contaminating the wellbore. Another common problem is that the outer metal armor may separate from the rubber jacket, resulting in the inner electrical cable slipping out and away from the outer metal armor. Similarly, the rubber jacket may separate from the inner cable, thereby exposing the inner cable and/or allowing the inner cable to slip out and away from the protective outer jacket and armor. When the inner cable slips away, the inner cable is left exposed to corrosive materials in the well, as well as to impact and abrasion, which normally ultimately causes the cable and/or pump to fail downhole. When the cable and/or pump fails electrically, it must be brought to the surface and repaired or replaced. This is extremely timely and expensive, as usually the entire pipe string must be brought up to bring up the pump and cable and the end of the pipe string. Accordingly, there exists a need for a cable for use with a downhole motor that is more capable of withstanding the extreme environment downhole.

### SUMMARY

In one aspect, embodiments disclosed herein relate to a method of manufacturing a cable for use with a downhole pump. The method includes providing at least one metallic conductor, bonding at least one polymer layer to the at least one metallic conductor, thereby forming a cable core, and bonding at least one strength member layer to the cable core, the at least one strength member layer comprising a plurality of polymer-bonded strength members.

In another aspect, embodiments disclosed herein relate to a cable for use with a downhole pump. The cable includes a cable core having at least one metallic conductor and at least one polymer layer bonded to the at least one metallic conductor, the cable further includes and at least one strength member layer bonded to the cable core, the at least one strength member layer comprising a plurality of polymer-bonded strength members.

In another aspect, embodiments disclosed herein relate to a method of manufacturing a cable for use with a downhole pump. The method includes providing at least one metallic conductor, bonding at least one polymer layer to the at least one metallic conductor, thereby forming a cable core, and bonding at least one strength member layer to the cable core, in which the cable is continuously bonded from the at least one metallic conductor to the at least one strength member layer.

In yet another aspect, embodiments disclosed herein relate to a cable for use with a downhole pump. The cable includes a cable core having at least one metallic conductor and at least one polymer layer bonded to the at least one metallic conductor. The cable further includes at least one strength member layer bonded to the cable core, in which the cable is continuously bonded from the at least one metallic conductor to the at least one strength member layer.

Other aspects and advantages will be apparent from the following description and the appended claims.

### BRIEF DESCRIPTION OF DRAWINGS

FIG. 1 shows a prior art depiction of a submersible pump attached to a pipe string in a well.

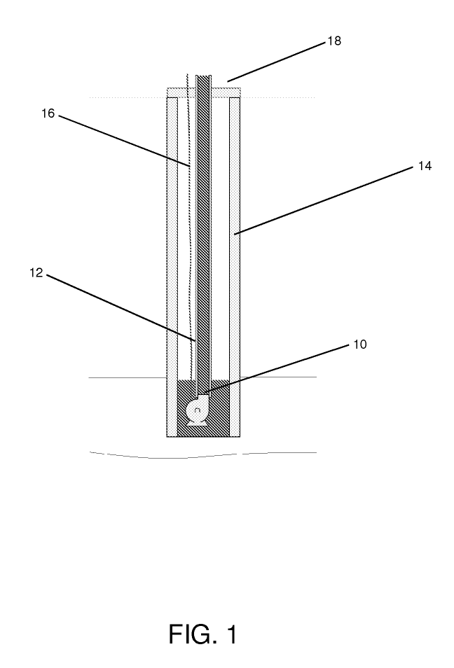

FIGS. 2A and 2B show methods for manufacturing a cable in accordance with one or more embodiments of the present disclosure.

FIGS. 3A and 3B show methods for manufacturing a pump cable in accordance with one or more embodiments of the present disclosure.

FIG. 4A shows a cable in accordance with one or more embodiments of the present disclosure.

FIG. 4B shows a method for manufacturing a pump cable in accordance with one or more embodiments of the present disclosure.

### DETAILED DESCRIPTION

In the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description.

Embodiments disclosed herein relate to a cable for use with a downhole pump, in which the cable provides at least power to the downhole pump. In addition to power, the cable may provide support for the downhole pump, such as by using the cable to suspend and support the pump while downhole. The downhole pump may be any pump known in the art, such as an electrical submersible pump, described above. As such, a cable of the present disclosure may be capable of better withstanding long-term exposure to the severe environment encountered downhole, such as from the heat, the pressure, gases, fluids, and/or any other elements or conditions common to the downhole environment.

Accordingly, embodiments disclosed herein relate to and include a cable that is continuously bonded. As used herein, the term “continuously bonded” refers to a cable having multiple layers, in which each layer is completely bonded to the next layer. In such a cable, the multiple layers of the cable are completely bonded both along the axial length of the cable and across the diameter of the cable. As such, a tear and/or break to one of the layers and/or portions of the cable does not affect any other layers and/or portions of the cable.

A cable in accordance with the present disclosure may include a cable core having one or more metallic conductors with one or more polymer materials layers bonded to the metallic conductors. One or more strength member layers are bonded to the cable core, in which the strength member layers may include one or more polymer-bonded strength members. As such, from the manufacturing process, and from the materials used within the cable, the cable is continuously bonded from the innermost metallic conductors of the cable to the outermost strength member layer of the cable.

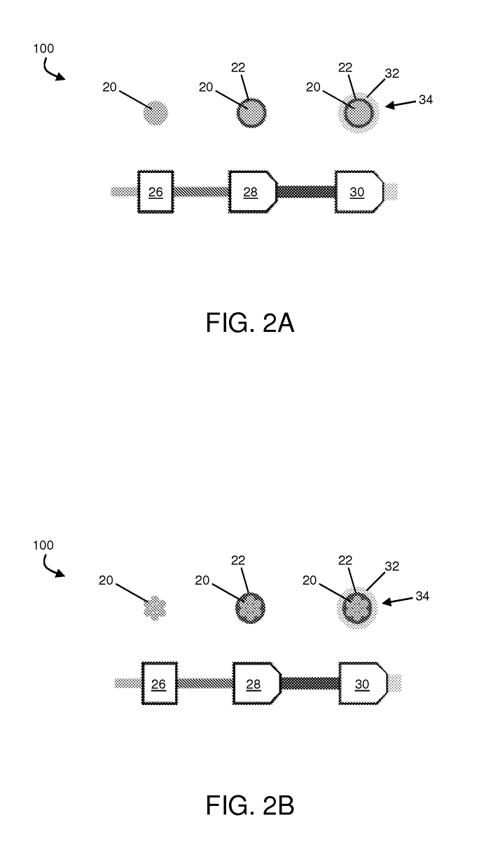

Referring to FIGS. 2A and 2B, one or more methods for manufacturing a cable 100 in accordance with one or more embodiments of the present disclosure are shown. Particularly, FIGS. 2A and 2B show one or more methods for manufacturing an insulated conductor cable 34, in which one or more insulated conductor cables 34 may be used to form a cable in accordance with embodiments disclosed herein (discussed more below). As previously mentioned, the cable 100 includes one or more metallic conductors 20, in which the metallic conductor 20 may be a solid conductor wire, such as shown particularly in FIG. 2A, or may be a stranded conductor wire, such as shown particularly in FIG. 2B. Further, the metallic conductor 20 may be a shaped wire and/or may be a compacted wire.

Accordingly, the manufacture of the cable 100 may begin with heating the metallic conductors 20 with a heater 26 (e.g., infrared heater and/or other heat source) such that the surfaces of the metallic conductors 20 may be able to be modified. After heating, one or more polymer layers may be bonded to the metallic conductors 20. For example, as shown in FIGS. 2A and 2B, the cables 100 may include a first polymer layer 22 and a second polymer layer 32. However, those having ordinary skill in the art will appreciate that the present disclosure is not so limited, as a cable of the present disclosure may only include one polymer layer, or may include three or more polymer layers.

The first polymer layer 22 may be bonded to the metallic conductor 20 as the cable 100 may be extruded through the extruder 28. An extruder in accordance with the present disclosure may be used to shape an outer-profile of the cable as the cable passes through the extruder. As such, in FIGS. 2A and 2B, the extruder 28 may be used to extrude the first polymer layer 22 of the cable 100.

Accordingly, the first polymer layer 22 may include one or more polymer materials, as desired. For example, in one embodiment, the first polymer layer 22 may include a modified (i.e., amended) polymer material, such as to chemically bond with the metallic conductor 20, and/or may include a non-modified polymer material, such as a polymer material having a low dielectric constant, for the primary insulation for the metallic conductor 20. In an embodiment in which the first polymer layer 22 includes both the modified polymer and non-modified polymer, the modified and non-modified polymers may be bonded to the metallic conductor 20 during extrusion of the cable 100. Further, the modified and non-modified polymers may be co-extruded on to the metallic conductor 20 after heating, such as by using a co-extruder for the extruder 28. Co-extrusion may utilize melting and delivering a desired amount of the different polymer materials through a single extrusion die or head to have a desired shape and/or size for the cable.

Referring still to FIGS. 2A and 2B, after bonding the first polymer layer 22 to the metallic conductor 20, the cable 100 may have a second polymer layer 32 bonded to the first polymer layer 22. The second polymer layer 32 may be extruded over the first polymer layer 22 using an extruder 30, in which the second polymer layer 32 bonds to the first polymer layer 22. In such an embodiment, the second polymer layer 32 may include a soft polymer, discussed further below. Accordingly, FIGS. 2A and 2B show insulated conductor cables 34 formed having the metallic conductor 20 with the first polymer layer 22 and the second polymer layer 32, though the insulated conductor cables 34 needs only to be formed with at least polymer layer.

Those having ordinary skill in the art will appreciate that the material used for the metallic conductor for a cable in accordance with the present disclosure may include any metallic conducting material known in the art. As such, in one or more embodiments, a metallic conductor may include one or more of the following: a solid copper wire, a stranded copper wire, a compacted copper wire, a shaped copper wire, a copper clad steel wire, an aluminum clad steel wire, a titanium clad copper wire, and/or any other conducting wire known in the art.

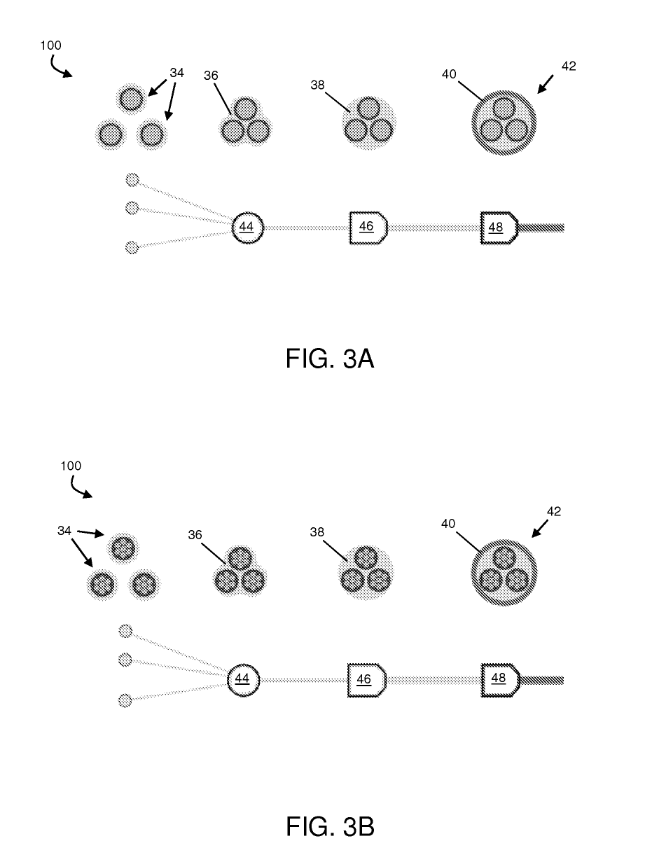

Referring now to FIGS. 3A and 3B, one or more methods for manufacturing the cable 100 in accordance with one or more embodiments of the present disclosure are shown. Particularly, FIGS. 3A and 3B show one or more methods for manufacturing a cable core 42, in which the cable core 42 may be used to form a continuously bonded cable in accordance with one or more embodiments disclosed herein. As previously mentioned, the cable core 42 includes one or more metallic conductors 20. In an embodiment having more than one metallic conductor 20, more than one insulated conductor cable 34 may be used to manufacture the cable core 42. For example, as shown in FIGS. 3A and 3B, three insulated conductor cables 34 may be used to manufacture the cable core 42.

Accordingly, the manufacture of the cable 100 continues with cabling the insulated conductor cables 34 together, such as disposing the insulated conductor cables 34 together and passing the cables 34 through a shaping die 44. As the insulated conductor cables 34 are cabled together, the insulated conductor cables 34 may deform against each other such that substantially all of the interstitial spaces between the insulated conductor cables 34 are filled. Further, the insulated conductor cables 34 may be heated to facilitate the cabling and bonding of the insulated conductor cables 34 to each other.

After cabling the insulated conductor cables 34 together, the cable 100 may be extruded through an extruder 46, in which additional polymer material 36 may be extruded over and bonded to the cable 100. Particularly, additional polymer material 36 may be added to the insulated conductor cables 34 and extruded through the extruder 46, such as to give the cable 100 a circular profile after passing through the extruder 46. Further, if desired, a polymer layer 40 may be bonded to the insulated conductor cable 34 as the cable 100 may be extruded through an additional extruder 48. When passing through the extruder 40, a layer of jacketing polymer may be extruded over and bonded to the cable 100 to complete the cable core 42. Those having ordinary skill in the art will appreciate that, though a cable core is shown having multiple metallic conductors with multiple polymer layers bonded thereto, the present disclosure is not so limited, as a cable core in accordance with the present disclosure needs to only include at least one metallic conductor having at least one polymer layer bonded thereto.

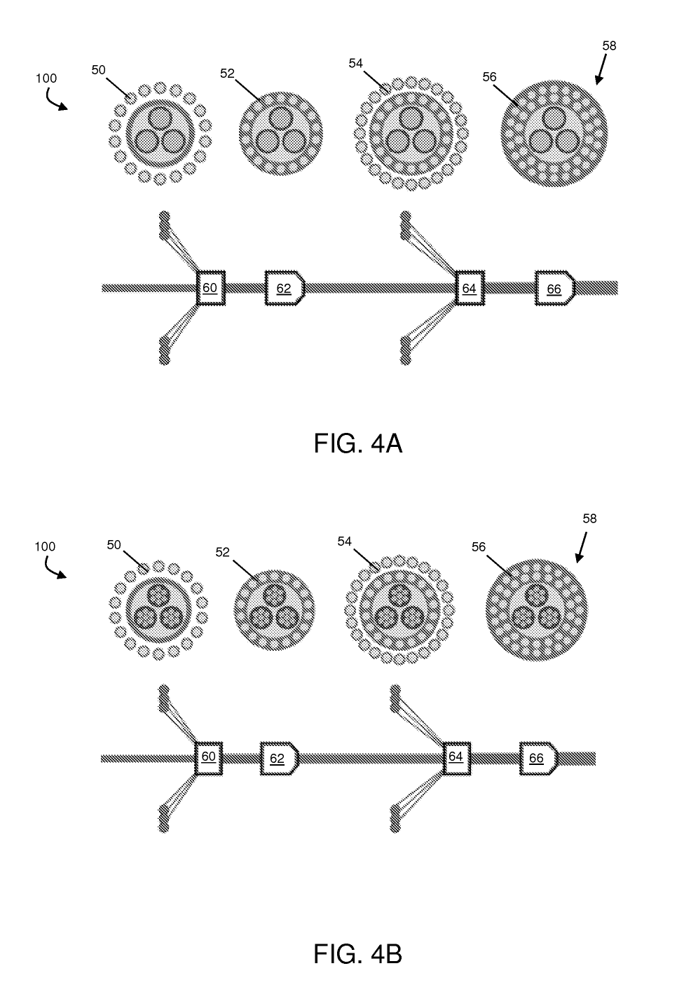

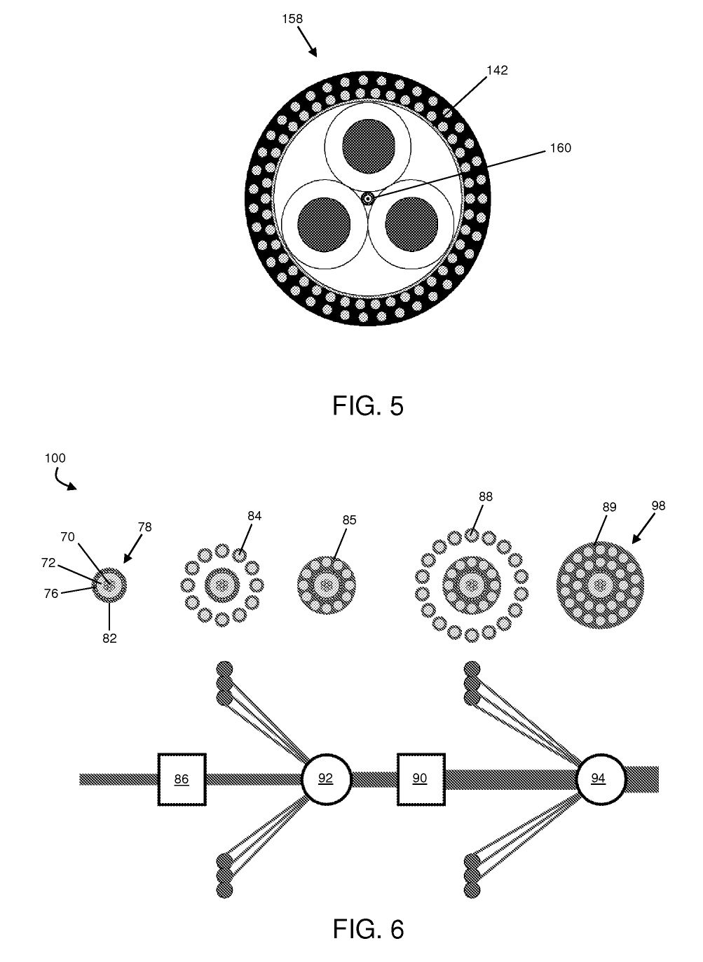

Referring now to FIGS. 4A and 4B, one or more methods for manufacturing the cable 100 in accordance with one or more embodiments of the present disclosure are shown. Particularly, a continuously bonded cable 58 may be formed using a cable core, such as the cable core 42 discussed previously with respect to FIGS. 3A and 3B. Further, as discussed above, a cable in accordance with the present disclosure may include at least one strength member layer bonded to the cable core. For example, as shown in FIGS. 4A and 4B, the cable 100 may include a first strength member layer 52 and a second strength member layer 56. However, those having ordinary skill in the art will appreciate that the present disclosure is not so limited, as a cable of the present disclosure may only include one strength member layer, or may include three or more strength member layers.

Accordingly, the manufacture of the cable 100 continues with cabling a plurality of polymer-bonded strength members 50 over the cable core 42. The polymer-bonded strength members 50 may be constructed in a similar fashion as the insulated conductor cables 34, discussed above, thereby having a metallic conductor with at least one polymer layer bonded thereto. The polymer-bonded strength members 50 may pass through a heater 60, thereby enabling the outer polymer layer of the polymer-bonded strength members 50 to slightly melt and deform against each other and against the cable core 42. As the polymer-bonded strength members 50 are cabled together, the polymer-bonded strength members 50 may substantially fill all of the interstitial spaces about the cable 100.

After cabling the polymer-bonded strength members 50 together, the cable 100 may be extruded through an extruder 62, in which additional polymer material may be extruded over and bonded to the cable 100. Particularly, additional polymer material may be added, as desired, to give the cable 100 a circular profile after passing through the extruder 62. As such, after cabling the polymer-bonded strength members 50 over the cable core 42, the cable 100 may include the first strength member layer 52 formed from the polymer-bonded strength members 50.

Referring still to FIGS. 4A and 4B, another strength member layer may be bonded to the cable 100. Particularly, the second strength member layer 56 may be bonded to the first strength member layer 52. Similar to the first strength member layer 52, the manufacture of the second strength member layer 56 beings with cabling another plurality of polymer-bonded strength members 54 over the first strength member layer 52. For example, the polymer-bonded strength members 54 may pass through another heater 64, thereby enabling the outer polymer layer of the polymer-bonded strength members 54 to slightly melt and deform against each other and against the first strength member layer 52. As the polymer-bonded strength members 54 are cabled together, the polymer-bonded strength members 54 may substantially fill all of the interstitial spaces about the cable 100.

After cabling the polymer-bonded strength members 54 together, the cable 100 may be further extruded through another extruder 66, in which additional polymer material may be extruded over and bonded to the cable 100. Particularly, additional polymer material may be added, as desired, to give the cable 100 a desired size and shape, such as a circular profile, after passing through the extruder 66. As such, after cabling the polymer-bonded strength members 54 over the first strength member layer 52, the cable 100 may include the second strength member layer 56 to form the continuously bonded cable 58. Accordingly, the multiple layers of the continuously bonded cable 58 are completely bonded both along the axial length of the continuously bonded cable 58 and across the diameter of the continuously bonded cable 58.

Referring now to FIG. 5, a continuously bonded cable 158 in accordance with one or more embodiments of the present disclosure is shown. The continuously bonded cable 158 may be similar in construction to the continuously bonded cable 58 described above in FIGS. 3A and 3B, but the cable 158 may further include one or more additional communication wires therein. For example, a communication wire 160 may be included within the continuously bonded cable 158, such as by having the communication wire 160 disposed within a cable core 142 of the cable 158. As such, in one embodiment, the communication wire 160 may include an optical fiber, in which the optical fiber may be used to enable further communication through the cable 158.

Referring now to FIG. 6, one or more methods for manufacturing the cable 100 in accordance with one or more embodiments of the present disclosure are shown. Particularly, a continuously bonded cable 98 may be formed using a cable core 78. In FIG. 6, the cable core 78 may include one or more metallic conductors 70, in which the metallic conductors 70 may be stranded, shaped, and/or compacted with multiple individual elements (as shown), and/or may be formed as a single solid element (not shown here). Further, similar to above, a first polymer layer 72 may be bonded to the metallic conductors 70, such as by heating and/or extruding the polymer layer 72 onto the cable 100.

If desired, one or more conductors 76, such as solid copper conductors, may be extruded and bonded over the first polymer layer 72, such as to provide a shield for the metallic conductors 70. The conductors 76 may be applied helically over the first polymer layer 72, and then passed through a heater (e.g., an IR heater) to at least partially melt the conductors 76 to the first polymer layer 72. This may allow for the polymeric material on the conductors 76 to fill substantially all interstitial spaces and bond to the conductors 76 to the first polymer layer 72.

Further, if desired, a second polymer layer 82 may be bonded to the cable 100, such as by bonding the second polymer layer 82 to the first polymer layer 72 and/or to the conductors 76. For example, to complete the cable core 78, the cable 100 may be extruded through an additional extruder 86. When passing through the extruder 86, a layer of jacketing polymer may be extruded over and bonded to the cable 100 to complete the cable core 78. Those having ordinary skill in the art will appreciate that, though a cable core is shown having multiple metallic conductors with multiple polymer layers bonded thereto, the present disclosure is not so limited, as a cable core in accordance with the present disclosure need to only include at least one metallic conductor having at least one polymer layer bonded thereto.

As discussed above, a cable in accordance with the present disclosure may include at least one strength member layer bonded to the cable core. As such, and continuing with FIG. 6, the cable core 78 may have a first strength member layer 85 and a second strength member layer 89. Similar to discussed above, the cable core 78 may be heated, such as by passing through a heater 86, and a plurality of polymer-bonded strength members 84 may be cabled over the cable core 78, such as disposing the polymer-bonded strength members 84 together and passing the strength members 84 through a shaping die 92. As the polymer-bonded strength members 84 are cabled together, the strength members 84 may deform against each other such that substantially all of the interstitial spaces between the polymer-bonded strength members 84 are filled. Further, the polymer-bonded strength members 84 may be heated to facilitate the cabling and bonding of the polymer-bonded strength members 84 to each other, thereby forming the first strength member layer 85. Similarly, the second strength member layer 85 may be formed by passing the cable core 78 through an additional heater 90, and cabling a plurality of polymer-bonded strength members 88 to pass through a die 94.

As such, after cabling the polymer-bonded strength members 88 over the first strength member layer 85, the cable 100 may include the second strength member layer 89 to form the continuously bonded cable 98. Accordingly, the multiple layers of the continuously bonded cable 98 are completely bonded both along the axial length of the continuously bonded cable 98 and across the diameter of the continuously bonded cable 98. If needed, in some embodiments, an additional jacketing polymer may be extruded over the outside of the cable to create a circular profile outer jacket of the desired thickness.

In accordance with one or more embodiments of the present disclosure, the material used for the strength members of the polymer-bonded strength members described herein and/or the conductors bonded to the cable core described herein may be selected from galvanized improved plow steel of different carbon content, stainless steel, copper-clad steel, aluminum-clad steel, anodized aluminum-clad steel, titanium-clad steel, alloy 20Mo6HS, alloy GD31Mo, austenitic stainless steel, high strength galvanized carbon steel, titanium clad copper, and/or any other suitable strength material.

In accordance with one or more embodiments of the present disclosure, the material used for the polymer material encompassing the polymer-bonded strength members described herein and/or the conductors bonded to the cable core described herein may be selected from a modified polyolefin, for example, amended with one of several adhesion promoters such as unsaturated anhydrides (e.g., maleic-anhydride, or 5-norbornene-2,3-dicarboxylic anhydride), carboxylic acid, acrylic acid, silanes, and/or any other suitable polymer material. Such modified polyolefins with these adhesion promoters are commercially available under the following tradenames: ADMER® from Mitsui Chemical, Fusabond®, Bynel® from DuPont, and Polybond® from Chemtura. Rubbers such as ethylene propylene diene monomer (EPDM), or any other suitable modifiable polymer based on physical, electrical, and bonding characteristics may also be used to facilitate bonding between metals and polymers that would not otherwise bond.

In accordance with one or more embodiments of the present disclosure, the material used for the polymer material encompassing the polymer-bonded strength members described herein and/or the conductors bonded to the cable core described herein may be selected from a modified TPX (4-methylpentene-1 based, crystalline polyolefin), for example, amended with one of several adhesion promoters selected from unsaturated anhydrides (mainly maleic-anhydride, or 5-norbornene-2, 3-dicarboxylic anhydride, carboxylic acid, acrylic acid, or silanes). TPX is commercially available from Mitsui Chemical, and is an amended TPX (4-methylpentene-1 based, crystalline polyolefin) with these adhesion promoters.

In accordance with one or more embodiments of the present disclosure, modified fluoropolymers containing adhesion promoters may be used as desired to facilitate bonding between materials that would not otherwise bonded. These adhesion promoters may include unsaturated anhydrides (mainly maleic-anhydride, or 5-norbornene-2,3-dicarboxylic anhydride, carboxylic acid, acrylic acid, and silanes). Examples of commercially available fluoropolymers modified with adhesion promoters may include: perfluoroalkoxy polymer (PFA) from DuPont Fluoropolymers, Modified PFA resin; Tefzel® from DuPont Fluoropolymers, Modified ETFE resin which is designed to promote adhesion between polyamide and fluoropolymer; Neoflon™-modified Fluoropolymer from Daikin America, Inc., which is designed to promote adhesion between polyamide and fluoropolymer; fluorinated ethylene propylene (FEP) from Daikin America, Inc.; ethylene tetrafluoroethylene (ETFE) from Daikin America, Inc.; or ethylene-fluorinated ethylene propylene (EFEP) from Daikin America, Inc.

In accordance with one or more embodiments of the present disclosure, a non-modified polymer material may include, for example, a polyolefin polymer material, which can be used “as is” or which can have its polymer matrix reinforced with carbon, glass, aramid, and/or any other suitable natural or synthetic fiber. Along with fibers in the polymer matrix, any other reinforcing additives may be used, such as micron sized PTFE, Graphite, Ceramer™ may be used, including: high density polyethylene (HDPE); low density polyethylene (LDPE); ethylene tetrafluoroethylene (PP); PP copolymers; EPDM elastomers; Engage family of thermoplastic elastomers; and any insulating rubber, thermoplastic, or thermoset. These examples of commercially available fluoropolymers may be used “as is” or may have their polymer matrix reinforced with carbon, glass, aramid, and/or any other suitable natural or synthetic fiber. Along with fibers in the polymer matrix, any other reinforcing additives, such as micron sized PTFE, Graphite, and Ceramer™ may be used, including: ethylene tetrafluoroethylene (ETFE) from DuPont; ethylene tetrafluoroethylene (ETFE) from Daikin America, Inc.; ethylene-fluorinated ethylene propylene (EFEP) from Daikin America, Inc.; perfluoroalkoxy polymer (PFA) from Dyneon™ Fluoropolymer; perfluoroalkoxy polymer (PFA) from Solvay Solexis, Inc.; perfluoroalkoxy polymer (PFA) from Daikin America Inc.; perfluoroalkoxy polymer (PFA) from DuPont Fluoropolymer, Inc.; and any other insulating perfluoro elastomers.

In accordance with one or more embodiments of the present disclosure, the materials used for the jacketing polymers may include, for example, polyolefins, which may be used “as is” or which may be modified or reinforced with carbon, glass, aramid, or any other suitable natural or synthetic fiber. Along with fibers in the polymer matrix, the polyolefins may also include other reinforcing additives such as micron sized PTFE, Graphite, and Ceramer™, including: high density polyethylene (HDPE); low density polyethylene (LDPE); ethylene tetrafluoroethylene (PP); PP copolymers; and Modified EPC or modified PP.

Further, in accordance with one or more embodiments of the present disclosure, the materials used for the jacketing polymers may also include, for example, polyamides, selected from the following: nylon 6; nylon 66; nylon 6/66; nylon 6/12; nylon 6/10; nylon 11; nylon 12; or any other modified nylons. Polyamides according to embodiments of the present disclosure may be commercially available under the following trade names: Orgalloy® RILSAN® or RILSAN® from Arkeme; BASF Ultramid® Miramid® from BASF; and Zytel® DuPont Engineering Polymers.

Furthermore, in accordance with one or more embodiments of the present disclosure, the materials used for the jacketing polymers may also include, for example, unmodified and reinforced fluoropolymers, which may be used “as is” or which may be reinforced with carbon, glass, aramid, or any other suitable natural or synthetic fiber. Along with fibers in the polymer matrix, the unmodified and reinforced fluoropolymers may also include other reinforcing additives such as micron sized PTFE, Graphite, and Ceramer™, including: ethylene tetrafluoroethylene (ETFE) from DuPont; ethylene tetrafluoroethylene (ETFE) from Daikin America, Inc.; ethylene-fluorinated ethylene propylene (EFEP) from Daikin America, Inc.; perfluoroalkoxy polymer (PFA) from Dyneon™ Fluoropolymer; perfluoroalkoxy polymer (PFA) from Solvay Solexis, Inc.; perfluoroalkoxy polymer (PFA) from Daikin America Inc.; perfluoroalkoxy polymer (PFA) from DuPont Fluoropolymer, Inc.

In accordance with one or more embodiments of the present disclosure, the materials used for the outer jacket over the solid or stranded insulated metallic conductors may include a soft filler polymer having a Shore A hardness between 10 and 100 and may allow the soft jackets to deform against one another and fill interstitial spaces between the conductors. Additional soft polymer material may be extruded over the soft-outer-jacketed conductors to complete filling the cable core. This additional soft polymer material may be, for example, Santoprene or any other suitable soft polymer that bonds to the insulation like engage, or other thermoplastic elastomers including fluoro thermoplastic elastomers.

Advantageously, embodiments of the present disclosure a continuously bonded cable and methods for forming the continuously bonded cable. The continuously bonded cable may be used to, at least, provide power to a downhole pump. However, a continuously bonded cable may further be capable of supporting the downhole pump, such as by deploying and retracting an electric submersible pump (or other equipment) downhole without the assistance of a pipe string, rig, or other deployment device. The continuously bonded cable of the present disclosure may also be capable of withstanding the harsh conditions common to the downhole environment.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method of manufacturing a cable for use with a downhole pump, the method comprising:
providing at least one metallic conductor;
bonding at least one polymer layer to the at least one metallic conductor, thereby forming a cable core; and
bonding at least one strength member layer to the cable core, the at least one strength member layer comprising a plurality of polymer-bonded strength members.

2. The method of claim 1, wherein the bonding the at least one polymer layer to the at least one metallic conductor comprises:
bonding a first polymer layer to the at least one metallic conductor;
extruding the first polymer layer of the cable; and
bonding a second polymer layer to the first polymer layer, thereby forming at least one insulated conductor cable;
wherein the cable core comprises the at least one insulated conductor cable.

3. The method of claim 2, wherein the at least one insulated conductor cable comprises a plurality of insulated conductor cables, wherein the bonding the at least one polymer layer to the at least one metallic conductor further comprises:
heating the plurality of insulated conductor cables; and
cabling the plurality of insulated conductor cables together, thereby forming the cable core.

4. The method of claim 2, wherein the bonding the first polymer layer to the cable comprises bonding a modified polymer material and a non-modified polymer material to the at least one metallic conductor.

5. The method of claim 1, wherein the cable is continuously bonded from the at least one metallic conductor to the at least one strength member layer.

6. The method of claim 1, wherein the bonding the at least one strength member layer to the cable core comprises:
bonding a first strength member layer to the cable core; and
bonding a second strength member layer to the first strength member layer.

7. The method of claim 1, wherein the bonding the at least one strength member layer to the cable core comprises:
heating the plurality of polymer-bonded strength members; and
cabling the plurality of polymer-bonded strength members over the cable core.

8. The method of claim 1, wherein the at least one metallic conductor comprises at least one of a solid wire, a stranded wire, a shaped wire, and a compacted wire.

9. The method of claim 1, wherein the cable core comprises an optical fiber disposed therein.

10. The method of claim 1, wherein the bonding the at least one polymer layer to the at least one metallic conductor comprises heating the at least one polymer layer, and wherein the bonding the at least one strength member layer to the cable core comprises heating the at least one strength member layer.

11. A cable for use with a downhole pump, comprising:
a cable core, comprising:
at least one metallic conductor; and
at least one polymer layer bonded to the at least one metallic conductor; and
at least one strength member layer bonded to the cable core, the at least one strength member layer comprising a plurality of polymer-bonded strength members.

12. The cable of claim 11, wherein the cable is continuously bonded from the at least one metallic conductor to the at least one strength member layer.

13. The cable of claim 11, wherein the at least one strength member layer comprises a first strength member layer and a second strength member layer, wherein the first strength member layer is bonded to the cable core, and wherein the second strength member layer is bonded to the first strength member layer.

14. The cable of claim 11, wherein the at least one polymer layer comprises at least one of a modified polymer material and a non-modified polymer material.

15. The cable of claim 11, wherein the at least one metallic conductor comprises at least one of a solid wire, a stranded wire, a shaped wire, and a compacted wire.

16. The cable of claim 11, wherein the cable core comprises an optical fiber disposed therein.

17. The cable of claim 11, wherein the at least one metallic conductor comprises a plurality of metallic conductors.

18. The cable of claim 11, wherein the cable core comprises a plurality of insulated conductor cables bonded to each other.

19. The cable of claim 11, wherein the cable core further comprises a plurality of conductors bonded to the at least one polymer layer.

20. A method of manufacturing a cable for use with a downhole pump, comprising:
providing at least one metallic conductor;
bonding at least one polymer layer to the at least one metallic conductor, thereby forming a cable core; and
bonding at least one strength member layer to the cable core;
wherein the cable is continuously bonded from the at least one metallic conductor to the at least one strength member layer.

21. The method of claim 20, wherein the bonding the at least one strength member layer to the cable core comprises:
bonding a first strength member layer to the cable core; and
bonding a second strength member layer to the first strength member layer.

22. The method of claim 20, wherein the at least one strength member layer comprises a plurality of polymer-bonded strength members.

23. The method of claim 22, wherein the bonding the at least one strength member layer to the cable core comprises:
heating the plurality of polymer-bonded strength members; and
cabling the plurality of polymer-bonded strength members over the cable core.

24. The method of claim 20, wherein the bonding the at least one polymer layer to the at least one metallic conductor comprises:
bonding a first polymer layer to the at least one metallic conductor;
extruding the first polymer layer of the cable; and
bonding a second polymer layer to the first polymer layer, thereby forming at least one insulated conductor cable;
wherein the cable core comprises the at least one insulated conductor cable.

25. The method of claim 24, wherein the at least one insulated conductor cable comprises a plurality of insulated conductor cables, wherein the bonding the at least one polymer layer to the at least one metallic conductor further comprises:
heating the plurality of insulated conductor cables; and
cabling the plurality of insulated conductor cables together, thereby forming the cable core.

26. The method of claim 20, wherein the bonding the at least one polymer layer to the at least one metallic conductor comprises heating the at least one polymer layer, and wherein the bonding the at least one strength member layer to the cable core comprises heating the at least one strength member layer.

27. A cable for use with a downhole pump, comprising:
a cable core, comprising:
at least one metallic conductor; and
at least one polymer layer bonded to the at least one metallic conductor; and
at least one strength member layer bonded to the cable core;
wherein the cable is continuously bonded from the at least one metallic conductor to the at least one strength member layer.

28. The cable of claim 27, wherein the at least one strength member layer comprises a plurality of polymer-bonded strength members.

29. The cable of claim 27, wherein the at least one strength member layer comprises a first strength member layer and a second strength member layer, wherein the first strength member layer is bonded to the cable core, and wherein the second strength member layer is bonded to the first strength member layer.

30. The cable of claim 27, wherein the at least one polymer layer comprises at least one of a modified polymer material and a non-modified polymer material.

31. The cable of claim 27, wherein the cable core comprises an optical fiber disposed therein.

32. The cable of claim 27, wherein the at least one metallic conductor comprises a plurality of metallic conductors.
